(19) United States
(12) Patent Application Publication
(10) Pub. No.: US 2021/0223903 A1
(43) Pub. Date: Jul. 22, 2021

(54) CONTROL METHOD FOR DISPLAY SCREEN, AND ELECTRONIC DEVICE

(71) Applicant: Wuhan China Star Optoelectronics Technology Co., LTD., Wuhan, Hubei (CN)

(72) Inventor: Qingcheng ZUO, Wuhan (CN)

(21) Appl. No.: 16/651,257

(22) PCT Filed: Nov. 21, 2018
(86) PCT No.: PCT/CN2018/116572

§ 371 Date: Mar. 26, 2020

(30) Foreign Application Priority Data
Sep. 27, 2018 (CN) 201811134410.X

(51) Int. Cl. G06F 3/041; G09G 3/20; G06F 3/044

(52) U.S. Cl. CPC G06F 3/0416; G09G 3/2007; G09G 2330/021; G09G 2320/0686; G06F 3/044

(57) ABSTRACT

The present invention provides a control method for a display screen and an electronic device. The control method includes: receiving a first electrical signal of the touch layer, and outputting a location information of a first region performing a touch operation on the touch layer; outputting a location information of a second region corresponding to the first region according to the location information of the first region; outputting a second electrical signal to the second region according to the first electrical signal; and decreasing a voltage value of a pixel unit in the second region according to the second electrical signal.

### BACKGROUND OF INVENTION

### Field of Invention

The present invention relates to a field of displays, and in particular, to a method for a display screen and an electronic device.

### Description of Prior Art

With the development of the mobile phone display industry, users tend to have high-resolution, large-screen mobile phones. Because of mobile phone battery limitations, the battery life of the mobile phone will make certain concessions.

Existing display screens consume a large amount of power when in a high gray scale state, while the power consumption is small or close to zero when the screen is in a low gray scale state. When the user performs a touch operation, because the finger itself is a non-transparent object, the touch area in the display screen will be blocked by the user's finger, and the touch region will continue to display at this time, resulting in waste of power consumption.

Therefore, there is a need for a display screen to solve the above problems.

### SUMMARY OF INVENTION

The present invention provides a control method for a display screen and an electronic device to solve the technical problem of wasting power consumption of existing display screens when performing a touch operation.

To solve the above technical problem, the present invention provides the following the technical solution:

The present invention provides a method for controlling a display screen, wherein the display screen includes a touch layer and a display layer, and the method includes:

receiving a first electrical signal of the touch layer, and outputting location information of a first region of the touch layer on which a touch operation is performed; outputting location information of a second region of the touch layer corresponding to the first region according to the location information of the first region; outputting a second electrical signal to the second region according to the first electrical signal; and decreasing a voltage value of pixel units in the second region according to the second electrical signal.

In the control method of the present invention, the first electrical signal is a current variation of a touch module corresponding to the first region.

In the control method of the present invention, an area of the first region is not greater than an area of the second region.

In the control method of the present invention, an orthographic projection of the first region in the second region is located within the second region.

In the control method of the present invention, at least one of the pixel units is disposed in the second region, and each of the pixel units corresponds to a same second electrical signal.

In the control method of the present invention, the second electrical signal is configured to reduce a grayscale value of each of the pixel units in the second region.

In the control method of the present invention, the second electrical signal is configured to cause the pixel units in the second region not to emit light.

In the control method of the present invention, at least one of the pixel units is disposed in the second region, and each of the pixel units corresponds to different second electrical signals.

In the control method of the present invention, in the pixel units of the second region, a grayscale value of a border region is greater than a grayscale value of a center region.

The present invention also provides an electronic device including a display screen and a controller configured to execute a number of instructions stored in a memory, wherein the instructions include a control method of the display screen, the display screen including a touch layer and a display layer, wherein the control method includes: receiving a first electrical signal of the touch layer, and outputting location information of a first region of the touch layer on which a touch operation is performed; outputting location information of a second region of the display layer corresponding to the first region according to the location information of the first region; outputting a second electrical signal to the second region according to the first electrical signal; and decreasing a voltage value of pixel units in the second region according to the second electrical signal.

In the electronic device of the present invention, the first electrical signal is a current variation of a touch module corresponding to the first region.

In the electronic device of the present invention, an area of the first region is not greater than an area of the second region.

In the electronic device of the present invention, an orthographic projection of the first region in the second region is located with the second region.

In the electronic device of the present invention, at least one of the pixel units is disposed in the second region, and each of the pixel units corresponds to a same second electrical signal.

In the electronic device of the present invention, the second electrical signal is configured to reduce a grayscale value of each of the pixel units in the second region.

In the electronic device of the present invention, the second electrical signal is configured to cause the pixel units in the second region not to emit light.

In the electronic device of the present invention, at least one of the pixel units is disposed in the second region, and each of the pixel units corresponds to different second electrical signals.

In the electronic device of the present invention, in the pixel units of the second region, a grayscale value of a border region is greater than a grayscale value of a center region.

The beneficial effects are as follows: the present invention is applied to identify an region of the display screen on which touch operation is performed, to reduce the grayscale value of the pixel unit in the region, thereby reducing waste of power consumption and improving the endurance of the corresponding electronic device.

### BRIEF DESCRIPTION OF THE DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a step flow diagram of a control method for a display screen according to the present invention.

### DETAILED DESCRIPTION OF THE PREFERRED EMBODIMENTS

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references. The spatially relative terms are intended to encompass different orientations in addition to the orientation as depicted in the figures.

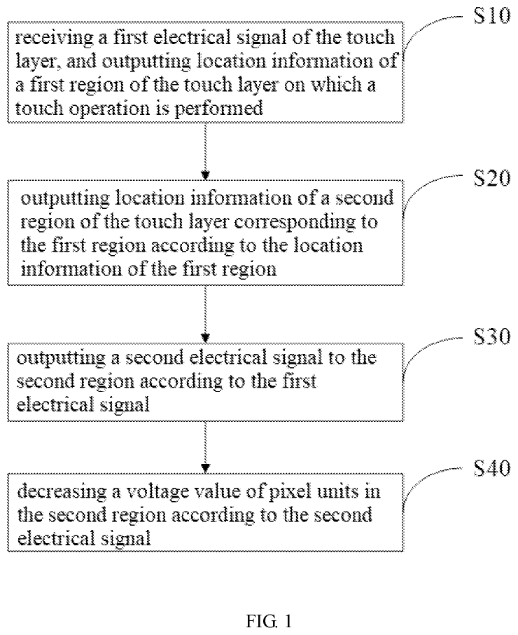

Please refer to FIG. 1. FIG. 1 is a step flow diagram of a control method for a display screen according to the present invention.

The display screen includes a touch layer and a display layer, and the control method comprises:

S10. receiving a first electrical signal of the touch layer, and outputting location information of a first region of the touch layer on which a touch operation is performed.

In this step, a display screen for the user to perform touch operation is first provided. The display screen may be, but is not limited to, one of an organic light-emitting diode (OLED) display screen, a micro light emitting diode display screen, and a sub-millimeter light emitting diode display screen.

When a user performs a touch operation on a display screen, a touch module in a touch layer of the display screen identifies the touch operation. In an embodiment, the touch module can be a touch electrode. The touch operation is monitored according to a current variation of a loop formed by a touch electrode in the touch region.

In this step, the touch layer is provided with a corresponding touch chip configured to output or receive a touch signal. In an embodiment, the touch chip is configured to output or receive a first electrical signal.

The touch chip corresponding to the touch layer outputs the first electrical signal according to the touch operation, that is, according to a current variation occurring in the first region on which the touch operation is performed. In an embodiment, the first electrical signal is a current variation of a touch module (touch electrode) corresponding to the first region.

In an embodiment, in a case that the display screen is a self-capacitive touch screen, when the user's finger touches the display screen, the loop of the touch module is is equivalent to a capacitor connected in parallel, thus increasing a total current of the loop of the touch module.

In an embodiment, in a case that the display screen is a mutual capacitive touch screen, when the user's finger contacts the display screen, the finger acts as a bridge so that adjacent touch electrodes and sensing electrodes are mutually capacitive, resulting in a decrease in capacitance, thus reducing a total current of the touch module.

The touch chip corresponding to the touch layer may further create location information of the first region on which the touch operation is performed on the touch layer according to the touch operation.

In an embodiment, the first region may be any region of the touch layer in the display screen. At least one of the touch electrodes is disposed in the first region, that is, position information of each of the touch electrodes in the first region, such as a specific coordinate range, is determined according to the touch operation detected by the touch electrodes.

S20. outputting location information of a second region of the touch layer corresponding to the first region according to the location information of the first region.

In this step, the touch chip transmits the location information of the first region to the controller, and the controller sends the location information of the second region of the display layer corresponding to the first region to the driving chip. For example, when the touch electrodes are transparent electrodes, each of the touch electrodes corresponds to a plurality of pixel units in the display layer.

In an embodiment, the location information of the second region may be the coordinates of each of the pixel units in the second region.

In an embodiment, an area of the first region is no greater than an area of the second region. The area of the first region may be equal to or smaller than the area of the second region.

In an embodiment, an orthographic projection of the first region in the second region is located within the second region. When a user performs a touch operation, because a user's finger blocks image in the second region, the display screen of the second region is non-visual to the user. Because the user cares about the touch operation, even if the grayscale value of the touch region and a small region around the touch region is changed, the user's experience is not affected.

S30. outputting a second electrical signal to the second region according to the first electrical signal.

In this step, the display layer is provided with a corresponding driving chip for outputting or receiving a driving signal for driving the display of the display layer.

In an embodiment, the driving chip receives the first electrical signal of the controller and the location information of the second region, and simultaneously transmits the second electrical signal to the driving module corresponding to the second region.

In an embodiment, the second electrical signal is used to reduce a voltage value in the second region that provides illumination of the pixel unit.

S40. decreasing a voltage value of pixel units in the second region according to the second electrical signal.

In this step, the driving module corresponding to the second region receives a second electrical signal from the driving chip, and adjusts a display state of the pixel units in the second region according to the second electrical signal.

In an embodiment, the second region may be any region of the display region on the display screen. At least one of the pixel units is disposed in the second region, and each of the pixel units corresponds to the same second electrical signal.

In an embodiment, the second electrical signal is for reducing a grayscale value of a pixel unit in the second region. When the touch operation is performed, the driving module corresponding to the second region passes the second electrical signal, so that the grayscale value of the pixel unit in the second area is lower than the state before the touch operation.

Because a user's finger blocks image in the second region, the display screen of the second region is non-visual to the user, and thus the grayscale value of the pixel unit in the second region can be decreased to reduce waste of power consumption.

In an embodiment, the pixel units of the second region have a grayscale value of zero.

In an embodiment, the second electrical signal causes the pixel units in the second region to not emit light. Because the user's finger blocks the image in the second region, the display screen of the second region is non-visual to the user. The driving module causes the pixel units in the second region to be in a non-lighting state by the second electrical signal, without affecting a progress of the touch operation, thereby reducing the waste of the power consumption of the display screen.

Each of the pixel units corresponds to a different second electrical signal. The driving chip outputs a plurality of the second electrical signals, and each of the second electrical signals corresponds to a pixel unit in the second region.

In an embodiment, the grayscale value of the pixel units located in a border region of the second region is greater than the grayscale value of the pixel units located in a center region of the second region. Because the user's finger completely blocks the touch region, a higher grayscale value of the pixel units in the center region is not necessary. The grayscale value of the pixel units in the second region is gradually decreased, which not only ensures a good display effect, but also reduces waste of power consumption.

The present invention also proposes an electronic device, wherein the electronic device includes a display screen and a controller configured to execute a plurality of instructions stored in the memory to implement the control method for the display screen.

The present invention provides a control method and an electronic device for a display screen. The display screen includes a touch layer and a display layer. The control method includes: receiving a first electrical signal of the touch layer, and outputting location information of a first region of the touch layer on which a touch operation is performed; outputting location information of a second region of the touch layer corresponding to the first region according to the location information of the first region; outputting a second electrical signal to the second region according to the first electrical signal; and decreasing a voltage value of pixel units in the second region according to the second electrical signal. The present invention reduces waste of power consumption and improves the endurance of the corresponding electronic device by identifying the region of the display screen on which the touch operation is performed.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A control method for a display screen, wherein the display screen comprises a touch layer and a display layer, and the control method comprises:
receiving a first electrical signal of the touch layer, and outputting location information of a first region of the touch layer on which a touch operation is performed;
outputting location information of a second region of the touch layer corresponding to the first region according to the location information of the first region;
outputting a second electrical signal to the second region according to the first electrical signal; and
decreasing a voltage value of pixel units in the second region according to the second electrical signal.

2. The control method according to claim 1, wherein the first electrical signal is a current variation of a touch module corresponding to the first region.

3. The control method according to claim 1, wherein an area of the first region is not greater than an area of the second region.

4. The control method according to claim 3, wherein an orthographic projection of the first region in the second region is located within the second region.

5. The control method according to claim 1, wherein at least one of the pixel units is disposed in the second region, and each of the pixel units corresponds to a same second electrical signal.

6. The control method according to claim 5, wherein the second electrical signal is configured to reduce a grayscale value of each of the pixel units in the second region.

7. The control method according to claim 5, wherein the second electrical signal is configured to cause the pixel units in the second region not to emit light.

8. The control method according to claim 1, wherein at least one of the pixel units is disposed in the second region, and each of the pixel units corresponds to different second electrical signals.

9. The control method according to claim 8, wherein in the pixel units of the second region, a grayscale value of a border region is greater than a grayscale value of a center region.

10. An electronic device, comprising a display screen and a controller configured to execute a number of instructions stored in memory, wherein the instructions comprise a control method of the display screen, the display screen comprising a touch layer and a display layer, wherein the control method comprises:
receiving a first electrical signal of the touch layer, and outputting location information of a first region of the touch layer on which a touch operation is performed;
outputting location information of a second region of the display layer corresponding to the first region according to the location information of the first region;
outputting a second electrical signal to the second region according to the first electrical signal; and
decreasing a voltage value of pixel units in the second region according to the second electrical signal.

11. The electronic device of claim 10, wherein the first electrical signal is a current variation of a touch module corresponding to the first region.

12. The electronic device of claim 10, wherein an area of the first region is not greater than an area of the second region.

13. The electronic device of claim 12, wherein an orthographic projection of the first region in the second region is located with the second region.

14. The electronic device of claim 10, wherein at least one of the pixel units is disposed in the second region, and each of the pixel units corresponds to a same second electrical signal.

15. The electronic device of claim 14, wherein the second electrical signal is configured to reduce a grayscale value of each of the pixel units in the second region.

16. The electronic device of claim 14, wherein the second electrical signal is configured to cause the pixel units in the second region not to emit light.

17. The electronic device of claim 10, wherein at least one of the pixel units is disposed in the second region, and each of the pixel units corresponds to different second electrical signals.

18. The electronic device of claim 17, wherein in the pixel units of the second region, a grayscale value of a border region is larger than a grayscale value of a center region.
